(19) United States
(12) Patent Application Publication
(10) Pub. No.: US 2026/0003932 A1
(43) Pub. Date: Jan. 1, 2026

(54) MEMORY LATENCY AWARE TILING FOR GENERALIZED MATRIX MULTIPLICATIONS ON PARALLEL PROCESSORS

(71) Applicant: ADVANCED MICRO DEVICES, INC., Santa Clara, CA (US)

(72) Inventor: Amna Masood, Santa Clara, CA (US)

(21) Appl. No.: 18/754,865

(22) Filed: Jun. 26, 2024

(51) Int. Cl. G06F 17/16

(52) U.S. Cl. CPC G06F 17/16

(57) ABSTRACT

A processor includes a plurality of processing elements. Each processing element is configured to obtain a first plurality of submatrices from a first input matrix and a second plurality of submatrices from a second input matrix. The first and second plurality of submatrices, for at least a first iteration of a plurality of matrix multiply iterations, each include at least one submatrix that is distinct from submatrices obtained by the other processing elements. The processing element performs one or more matrix multiplication operations on the first plurality of submatrices and the second plurality of submatrices to generate partial results for an output submatrix of an output matrix associated with the processing element. The processing element generates a portion of the output matrix by combining the partial results in the memory for the output submatrix. The output submatrices generated by each of the processing elements form the output matrix.

### BACKGROUND

Matrix multiplication is an operation implemented by applications in, for example, scientific computing, data analysis, and machine learning. In its most basic form, matrix multiplication involves calculating the product of two matrices. However, Generalized Matrix Multiplication (GEMM) extends this concept further. GEMM is a higher-order operation that involves additional operations, such as scaling and addition, making it more versatile but also computationally more demanding.

Traditional methods of matrix multiplication are well-established but face limitations when scaled to the larger and more complex matrices typical in modern applications, such as deep learning and big data analytics. The computational intensity of these operations, especially for large-scale data, poses challenges in terms of processing speed and resource utilization. Advanced techniques, including parallel processing, use of Graphics Processing Units (GPUs), and optimization algorithms, have been developed to address these challenges. Yet, these solutions often require specialized hardware or software environments and may not be universally applicable or optimally efficient across different types of matrix operations and data structures. Specifically, in the realm of GEMM, existing systems and methods often struggle with the scalability and efficiency required for large-scale GEMM operations, particularly in heterogeneous computing environments or with matrices that exhibit special properties (such as sparsity or high dimensionality).

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system in accordance with some implementations.

FIG. 2 is a block diagram of a parallel processor in accordance with some implementations.

FIG. 3 is a block diagram illustrating an example of a tiling technique for Generalized Matrix Multiplication (GEMM) kernel execution in accordance with some implementations.

FIG. 4 is a block diagram illustrating an example of matrix output tiles scheduled on compute units for GEMM kernel execution in accordance with some implementations.

FIG. 5 is example pseudocode for executing a GEMM kernel such that memory accesses are overlapped in different iterations of the GEMM kernel execution loop in accordance with some implementations.

FIG. 6. is a diagram illustrating an example of input data access patterns resulting from an early memory access technique for executing a GEMM kernel in accordance with some implementations.

FIG. 7 is a flow diagram illustrating a method of a parallel processor implementing an early memory access technique that overlaps memory accesses in different iterations of a GEMM kernel loop in accordance with some implementations.

FIG. 8 is a flow diagram illustrating another method of a parallel processor implementing an early memory access technique that overlaps memory accesses in different iterations of a GEMM kernel loop in accordance with some implementations.

FIG. 9. is a diagram illustrating an example of input data access patterns for a conventional GEMM kernel execution technique in accordance with some implementations.

### DETAILED DESCRIPTION

Generalized Matrix Multiplications (GEMMs) are a highly used kernel in various application domains, such as Machine Learning and High-Performance Computing algorithms and applications. During the execution of GEMMs on parallel processors, such as Graphics Processing Units (GPUs), the resulting matrix is typically divided into tiles to improve data reuse and enhance the arithmetic intensity of the algorithm. This approach aims to take full advantage of the extensive compute and limited memory bandwidth available on parallel processors. The tiles are mapped to parallel processor workgroups, which are then scheduled on the compute units of the parallel processor. The workgroups iterate over the input matrices to compute the final result.

During execution, it is common for several workgroups to simultaneously request identical data from the parallel processor memory, exhibiting temporal locality. This scenario often leads to these requests being consolidated within the memory system, effectively reducing the total number of inquiries directed at the parallel processor memory. As a consequence, this reduction in memory requests can lead to underutilization of the throughput capabilities of the parallel processor memory. Furthermore, during successive iterations of a matrix multiplication loop, the workgroups tend to encounter delays while waiting for subsequent data access. This situation often leads to the accumulation of latency, causing the kernel to become predominantly latency-bound in numerous instances. Moreover, many matrix sizes, especially small or skinny matrices, result in the GEMM execution being latency-bound, as there is not enough compute present to effectively hide the latency of required memory accesses, even on highly parallel machines like GPUs. This further exacerbates the issue of underutilization and delays, impacting the overall performance of the GEMM operations in critical applications.

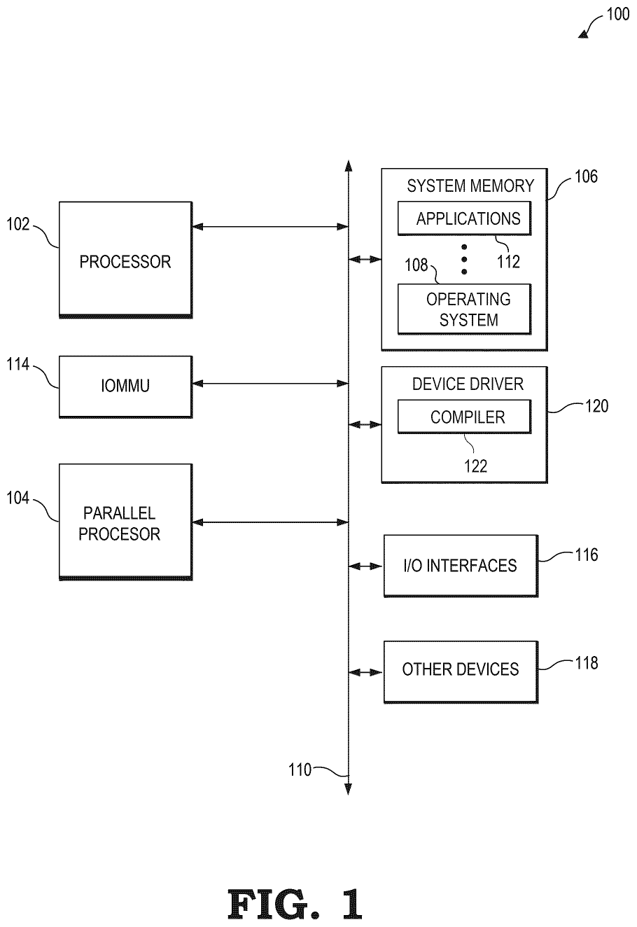

To improve the performance of GEMM kernels, FIG. 1 to FIG. 7 illustrate

systems and methods implementing early memory access techniques that enable the GPU or other parallel processor to maximize memory requests and reduce latency. As described in greater detail below, the early memory access techniques overlap memory accesses within iterations of GEMM kernels to fully utilize L2 cache capacity and memory throughput while reducing overall kernel latency and thread stall cycles. In many GEMM kernel implementations, tiling is employed to enable data reuse and improve arithmetic intensity. However, current techniques result in underutilization of memory throughput and high numbers of stall cycles. In contrast, the early memory access techniques of one or more implementations involve accessing tiles from input matrices as soon as possible to avoid accumulating memory access latency. This approach improves the utilization of L2 cache capacity and maximizes the number of memory requests that can be overlapped. For example, consider a GEMM kernel with two workgroups (each workgroup executing on a separate compute unit) executing simultaneously. Workgroup 1 is calculating output tile 1 and workgroup 2 is calculating output tile 2. They each are accessing tiles 0 to 15 from input matrix A. Instead of accessing the same tiles consecutively, the early access technique, in at least some implementations, has the first compute unit access tile 0, the second compute unit access tile 1, and so on, resulting in two requests to memory instead of one in the unoptimized algorithm.

As such. the early access techniques described herein provide multiple advantages over conventional techniques for GEMM kernels. For example, by issuing memory requests as early as possible, overall kernel latency is reduced, and L2 cache (or other) capacity and memory bandwidth are better utilized. In contrast to techniques such as loop unrolling, address swizzling, and prefetching, the early access techniques do not require additional resources or instructions, making it a more straightforward and efficient solution. Moreover, the early access techniques generate requests when they are actually needed, without any speculative pre-fetching of data. Furthermore, the early access techniques do not require hardware modifications, and their performance benefits extend across various domains, including artificial intelligence (AI) and high-performance computing (HPC) applications.

FIG. 1 illustrates an example processing system 100 (also referred to herein as “computing system 100”) in which one or more of the techniques described herein for reducing memory access latency by early generation of memory accesses can be implemented, particularly in the context of accelerating GEMM computations. It is noted that the number of components of the processing system 100 varies from implementation to implementation. For example, in at least some implementations, there is more or fewer of each component/subcomponent than the number shown in FIG. 1. In at least some implementations, the processing system 100 includes other components not shown in FIG. 1 or is structured in other ways than shown in FIG. 1. Also, the components of the processing system 100 are implemented as hardware, circuitry, firmware, software, or any combination thereof.

In at least some implementations, the processing system 100 includes one or more application processors 102, such as central processing units (CPU), and one or more parallel processors 104 (also referred to herein as “processor 104”), such as an accelerated processing device (APD), graphics processing unit (GPU), neural processing unit (NPU), and the like. A parallel processor 104 refers to any processing unit capable of executing multiple operations simultaneously. Examples of parallel processors include ADPs, vector processors, coprocessors, non-scalar processors, and other multithreaded processing units. APDs are a type of parallel processor designed to enhance processing speed and efficiency for specific tasks. An APD includes any cooperating collection of hardware and or software that perform functions and computations associated with accelerating graphics processing tasks, data-parallel tasks, nested data-parallel tasks in an accelerated manner with respect to resources such as conventional CPUs, conventional GPUs, and combinations thereof. Examples of APDs include graphics processing units (GPUs), general-purpose GPUs (GPGPUs), artificial intelligence (AI) processors, inference engines, machine-learning processors, and programmable logic devices such as field-programmable gate arrays (FPGAs), complex programmable logic devices (CPLDs), simple programmable logic devices (SPLDs), and the like.

In the implementation of FIG. 1, the processor 102 and the parallel processor 104 are formed and combined on a single silicon die or package to provide a unified programming and execution environment. This environment enables the parallel processor 104 to be used as fluidly as the processor 102 for some programming tasks. In other implementations, the processor 102 and the parallel processor 104 are formed separately and mounted on the same or different substrates. It should be appreciated that processing system 100, in at least some implementations, includes more or fewer components than illustrated in FIG. 1. For example, the processing system 100, in at least some implementations, additionally includes one or more input interfaces, non-volatile storage, one or more output interfaces, network interfaces, and one or more displays or display interfaces.

As illustrated in FIG. 1, the processing system 100 also includes a system memory 106, an operating system (OS) 108, a communications infrastructure 110, one or more software applications 112, an input-output memory management unit (IOMMU) 114, input/output (I/O) interfaces 116, and other devices 118. Access to system memory 106 is managed by a memory controller (not shown) coupled to system memory 106. For example, requests from the processor 102 or other devices for reading from or for writing to system memory 106 are managed by the memory controller. In some implementations, the one or more applications 112 include various programs or commands to perform computations that are also executed at the processor 102. The processor 102 sends selected commands for processing at the parallel processor 104. The operating system 108 and the communications infrastructure 110 are discussed in greater detail below.

Within the processing system 100, the system memory 106 includes non-persistent memory, such as dynamic random-access memory (not shown). In at least some implementations, the system memory 106 stores processing logic instructions, constant values, variable values during execution of portions of applications or other processing logic, or other desired information. For example, in at least some implementations, parts of control logic to perform one or more operations on processor 102 reside within system memory 106 during execution of the respective portions of the operation by processor 102. During execution, respective applications, operating system functions, processing logic commands, and system software reside in system memory 106. Control logic commands that are fundamental to operating system 108 generally reside in system memory 106 during execution. In some implementations, other software commands (e.g., a set of instructions or commands used to implement a device driver 120) also reside in system memory 106 during execution of processing system 100.

The input-output memory management unit (IOMMU) 114 is a multi-context memory management unit. As used herein, context is considered the environment within which the kernels execute and the domain in which synchronization and memory management are defined. The context includes a set of devices, the memory accessible to those devices, the corresponding memory properties, and one or more command queues used to schedule execution of a kernel(s) or operations on memory objects. The IOMMU 114 includes logic to perform virtual to physical address translation for memory page access for devices, such as the parallel processor 104. In some implementations, the IOMMU 114 also includes, or has access to, a translation lookaside buffer (TLB) (not shown). The TLB is implemented in a content addressable memory (CAM) to accelerate translation of logical (i.e., virtual) memory addresses to physical memory addresses for requests made by the parallel processor 104 for data in system memory 106.

I/O interfaces 116 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB)). Various types of peripheral devices are coupled to I/O interfaces 116. Such peripheral devices include (but are not limited to) displays, keyboards, mice, printers, scanners, joysticks or other types of game controllers, media recording devices, external storage devices, network interface cards, and so forth. Other device(s) 118 are representative of any number and type of devices (e.g., multimedia device, video codec).

In at least some implementations, the communications infrastructure 110 interconnects the components of the processing system 100. Communications infrastructure 110 includes (not shown) one or more of a peripheral component interconnect (PCI) bus, extended PCI (PCI-E) bus, advanced microcontroller bus architecture (AMBA) bus, advanced graphics port (AGP), or other such communication infrastructure and interconnects. In some implementations, communications infrastructure 110 also includes an Ethernet network or any other suitable physical communications infrastructure that satisfies an application's data transfer rate requirements. Communications infrastructure 110 also includes the functionality to interconnect components, including components of the processing system 100.

A driver 120, such as device or kernel driver, communicates with a device (e.g., parallel processor 104) through an interconnect or the communications infrastructure 110. When a calling program invokes a routine in the device driver 120, the device driver 120 issues commands to the device. Once the device sends data back to the device driver 120, the device driver 120 invokes routines in an original calling program. In general, device drivers are hardware-dependent and operating-system-specific to provide interrupt handling required for any necessary asynchronous time-dependent hardware interface. The driver 120, in at least some implementations, controls operation of the parallel processor 104 by, for example, providing an application programming interface (API) to software (e.g., applications 112) executing on the processor 102 to access various functionality of the parallel processor 104. In some implementations, a compiler 122 is embedded within driver 120. The compiler 122 compiles source code into program instructions as needed for execution by components of the processing system 100, such as SIMD or SIMT units. During such compilation, the compiler 122 applies transforms to program instructions at various phases of compilation. In other implementations, the compiler 122 is a standalone application.

The processor 102 includes (not shown) one or more of a control processor, field-programmable gate array (FPGA), application-specific integrated circuit (ASIC), or digital signal processor (DSP). The processor 102 executes at least a portion of the control logic that controls the operation of the processing system 100. For example, in at least some implementations, the processor 102 executes the operating system 108 and one or more applications 112. In some implementations, the processor 102 initiates and controls the execution of the one or more applications 112 by distributing the processing associated with one or more applications 112 across the processor 102 and other processing resources, such as the parallel processor 104.

In at least some implementations, the parallel processor 104 executes commands and programs for selected functions, such as graphics operations and other operations that are particularly suited for parallel processing. In general, parallel processor 104 is frequently used for executing graphics pipeline operations, such as pixel operations, geometric computations, and rendering an image to a display. In some implementations, parallel processor 104 also executes compute processing operations (e.g., those operations unrelated to graphics such as video operations, physics simulations, computational fluid dynamics, etc.) based on commands or instructions received from the processor 102. For example, such commands include special instructions that are not typically defined in the instruction set architecture (ISA) of the parallel processor 104. In some implementations, the parallel processor 104 receives an image geometry representing a graphics image, along with one or more commands or instructions for rendering and displaying the image. In at least some implementations, the image geometry corresponds to a representation of a two-dimensional (2D) or three-dimensional (3D) computerized graphics image.

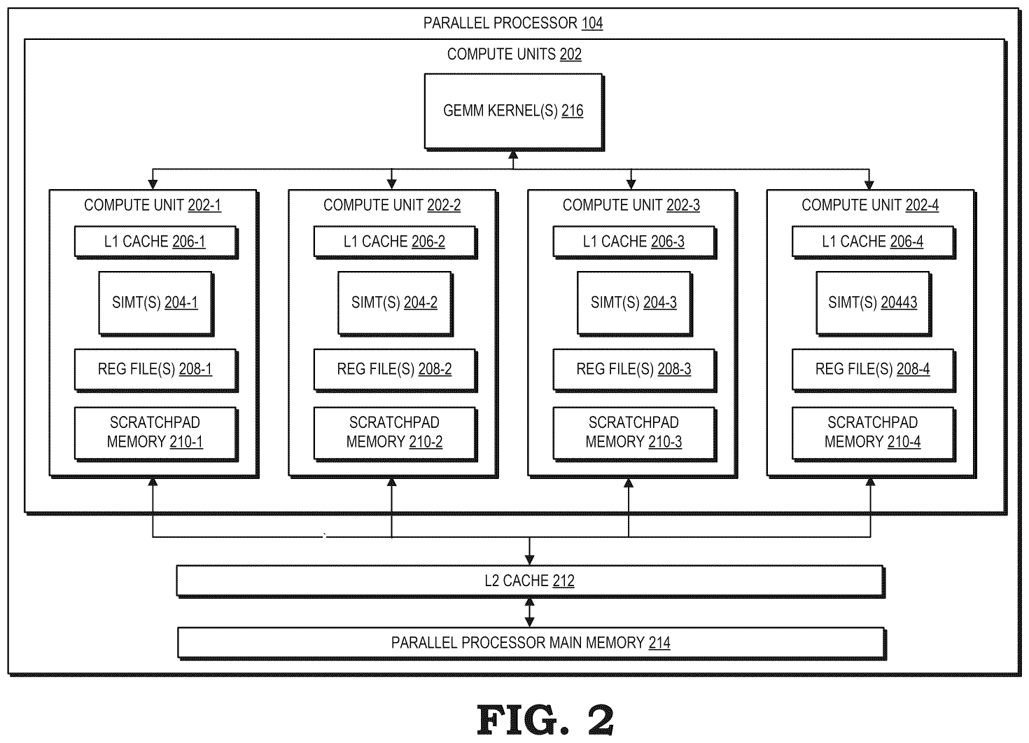

As described in greater detail below with respect to FIG. 2, the parallel processor 104 includes one or more parallel processing units to perform computations in accordance with a single-instruction-multiple-thread (SIMT) paradigm or a single-instruction-multiple-data (SIMD) paradigm. In one or more implementations of the parallel processor 104 is used to implement a GPU and, in these implementations, the parallel processing units are referred to as shader cores or streaming multi-processors (SMXs). Each parallel processing unit includes one or more processing elements, such as scalar floating-point units, vector floating-point units, arithmetic and logic units (ALUs), a combination thereof, and the like. In at least some implementations, the parallel processing units also include special-purpose processing units (not shown), such as inverse-square root units and sine/cosine units.

FIG. 2 is a block diagram illustrating a more detailed view of the parallel processor 104 in the processing system 100 of FIG. 1. It is noted that the number of components of the parallel processor 104 varies from implementation to implementation. For example, in at least some implementations, there are more or fewer of each component/subcomponent than the number shown in FIG. 2. In at least some implementations, the parallel processor 104 includes other components not shown in FIG. 2 or is structured in other ways than shown in FIG. 2. Also, the components of the parallel processor 104 are implemented as hardware, circuitry, firmware, software, or any combination thereof.

In at least some implementations, the parallel processor 104 executes commands and programs for selected functions, such as graphics operations and non-graphics operations that may be suited for parallel processing. The parallel processor 104, in at least some implementations, is used for executing graphics pipeline operations (e.g., pixel operations, geometric computations, etc.) and rendering an image to a display device based on commands received from the processor 102. The parallel processor 104 also executes compute processing operations that are not directly related to graphics operations, such as operations related to video, physics simulations, computational fluid dynamics, or other tasks, based on commands received from the processor 102.

The parallel processor 104, in at least some implementations, includes compute units (CU) 202 (illustrated as CU_0 202-1 to CU_3 202-4) that include one or more SIMT units 204 (illustrated as SIMT to SIMT 204-4), SIMD units, a combination thereof, and the like. In at least some implementations, the compute units 202 and their processing elements access the memory 106 via one or more interfaces. The SIMT units 204 perform operations at the request of the processor 102 in a parallel manner according to a SIMT paradigm. The SIMT paradigm is one in which multiple processing elements share a single program control flow unit and program counter, executing the same program but with different data. In one example, each SIMT unit comprises a number of lanes, where each lane may or may not execute the same instruction concurrently and can operate on different data. Lanes can be selectively disabled through predication if not all lanes are to execute a given instruction. Predication can also be utilized to handle programs with divergent control flow. Specifically, for programs with conditional branches or other instructions where control flow depends on calculations performed by individual lanes, predication of lanes corresponding to control flow paths not currently being executed, along with the serial execution of different control flow paths, allows for arbitrary control flow. This ensures that each lane within the SIMT unit can manage its own data-dependent execution while maintaining overall program coherence and efficiency.

In at least some implementations, the basic unit of execution in a compute unit 202 (also referred to herein as a “processing element 202”) is a work item. Each work item represents a single instantiation of a program that is to be executed in parallel in a particular lane. Work items, in at least some implementations, are executed simultaneously as a wavefront” on a single SIMT unit 204. One or more wavefronts are included in a “workgroup”, which includes a collection of work items designated to execute the same program. A workgroup is executed by executing each of the wavefronts that make up the workgroup. In other implementations, the wavefronts are executed sequentially on a single SIMT unit 204 or partially or fully in parallel on different SIMT units 204. Wavefronts, in at least some implementations, represent the largest collection of work items that can be executed simultaneously on a single SIMT unit 204. Thus, if commands received from the processor 102 indicate that a particular program is to be parallelized to such a degree that the program cannot execute on a single SIMT unit 204 simultaneously, then that program is broken up into wavefronts that are parallelized on two or more SIMT units 204 or serialized on the same SIMT unit 204 (or both parallelized and serialized). A scheduler (not shown in FIG. 2) performs operations related to scheduling various wavefronts on different compute units 202 and SIMT units 204.

The parallelism afforded by the compute units 202, in at least some implementations, is suitable for graphics-related operations such as pixel value calculations, vertex transformations, and other graphics operations. Thus, in some instances, a graphics pipeline (not shown in FIG. 2), which accepts graphics processing commands from the processor 102, provides computation tasks to the compute units 202 for execution in parallel. In at least some implementations, the compute units 202 are also used to perform computation tasks not related to graphics or not performed as part of the “normal” operation of a graphics pipeline (e.g., custom operations performed to supplement processing performed for operation of the graphics pipeline). An application 112 or other software executing on the processor 102 transmits programs that define such computation tasks to the parallel processor 104 for execution.

Each compute unit 202, in at least some implementations, further includes other components, such as an L1 cache 206 (illustrated as L1 cache 206-1 to L1 cache 206-4), one or more register files 208 (illustrated as register file 208-1 to register file 208-4), and scratchpad memory 210 (illustrated as scratchpad memory 210-1 to scratchpad memory 210-4). The L1 cache 206 is a memory that stores frequently accessed data and instructions, which reduces latency by enabling rapid data retrieval. This cache typically holds data that is spatially and temporally local to the current computations, such as texture data, frequently used variables, and loop counters, minimizing the time spent on memory fetches and thus improving overall performance.

The register files 208, in at least some implementations, are a high-speed storage area, including registers used for holding data and intermediate results during computation. The register files 208 provide quick access to variables and temporary storage needed for executing instructions. In at least some implementations, each thread in the SIMT unit 204 has its own set of registers within the register files 208, which maintain the state of the SIMT unit 204 and perform independent calculations. The size and organization of the register files 208 support the high degree of parallelism and rapid context switching of the SIMT architecture. The scratchpad memory 210, in at least some implementations, is a programmable on-chip memory used for temporary storage of data to be accessed and manipulated by the threads within the compute unit 202. This memory facilitates efficient data sharing and communication between threads, enabling collaborative computation and reducing the necessity to access slower off-chip memory.

FIG. 2 also shows that the parallel processor 104 includes other components, such as an L2 cache 212 and main memory 214 (also referred to as “parallel processor memory 214” or “global memory 214”). The L2 cache 212, in at least some implementations, acts as a shared resource for all compute units 202 by storing data and instructions that may be needed by multiple units, thereby reducing the need to access the slower main memory frequently. By maintaining a hierarchical cache structure, the parallel processor 104 balances speed and capacity, which ensures efficient data retrieval across varying levels of memory access. The main memory 214 is used to store a majority of the data and instructions operated on by the parallel processor 104, including textures, frame buffers, shaders, and computational data sets.

One type of operation performed by the parallel processor 104 is the execution of Generalized Matrix Multiplication (GEMM) kernels 216. GEMMs kernels 216 are beneficial for various high-impact applications, such as machine learning, high-performance computing, scientific simulations, and the like. These operations typically involve multiplying matrices, which is computationally intensive and benefits from parallel processing. GEMM kernels 216 typically perform operations of the form C=α(A×B)+βD, where A is a matrix of size M×K with M being the number of rows and K being the inner dimension, B is a matrix of size M×K, D is a matrix of size M×N, C is the result matrix of size M×N and α and β are scaling factors. For the sake of simplification, it is assumed that α and β are 0 and D is a zero matrix, reducing the GEMM equation to C=A×B. This operation is well-suited for execution on highly parallel processors, such as GPUs.

The execution process of a GEMM kernel 216 includes multiple operations or processes, such as kernel preparation, data transfer, kernel invocation, execution on parallel processor components, matrix multiplication execution, result collection, and post-processing. In at least some implementations, the kernel preparation process includes compiling GEMM kernels 216 written in high-level languages into machine code and allocating parallel processor memory 214 for Matrix A, Matrix B, and Matrix C, and any temporary buffers. The data transfer process includes copying the input matrices from host (CPU) system memory 106 to the main memory 214 and utilizing parallel processor computing frameworks for efficient memory transfers and synchronization. The kernel invocation process includes defining the grid and block dimensions for the kernel launch, which determines how the computation is divided among the compute units 202 of the parallel processor 104 and work items, and using an API call to launch the GEMM kernel 216 on the parallel processor 104. Execution on the components of the parallel processor 104 involves the compute units 202 of the parallel processor 104, where the kernel execution is distributed across multiple compute units 202 and their SIMD or SIMT units 204. For example, work items are grouped into wavefronts, which execute in lockstep on SIMT units 204 to perform parallel execution of instructions on multiple data elements. The matrix multiplication execution process includes dividing the resulting matrix C into smaller tiles to improve data reuse and arithmetic intensity, with each tile mapped to a workgroup. Work items within a workgroup load elements of Matrix A and Matrix B from the main memory 214 into local registers or shared memory, perform multiply-accumulate operations, and synchronize within workgroups to manage data dependencies and avoid race conditions.

The result collection process includes writing the partial results computed by each workgroup back to the main memory 214. Once all partial results are computed, the resulting Matrix C is transferred from the main memory 214 back to the system memory 106 (host memory). The post-processing process includes verifying the correctness of the output Matrix C and freeing the allocated main memory 214, along with handling any necessary cleanup operations.

As indicated above, tiling is typically implemented to efficiently execute GEMM kernels 216. With the tiling process, each thread block loads a tile from Matrix A and Matrix B to calculate the partial product of a corresponding tile of Matrix C. Tiling helps to increase computational intensity by reusing data loaded from the parallel processor's memory, which has limited bandwidth and higher latency. This technique is particularly effective for larger matrices. However, for many matrix sizes, especially small or narrow matrices, tiling alone may not be sufficient to address the issue of being latency-bound. In these cases, conventional GEMM execution techniques remain latency-bound because there is not enough computational demand to effectively hide the latency of required memory accesses, even on highly parallel machines such as parallel processors.

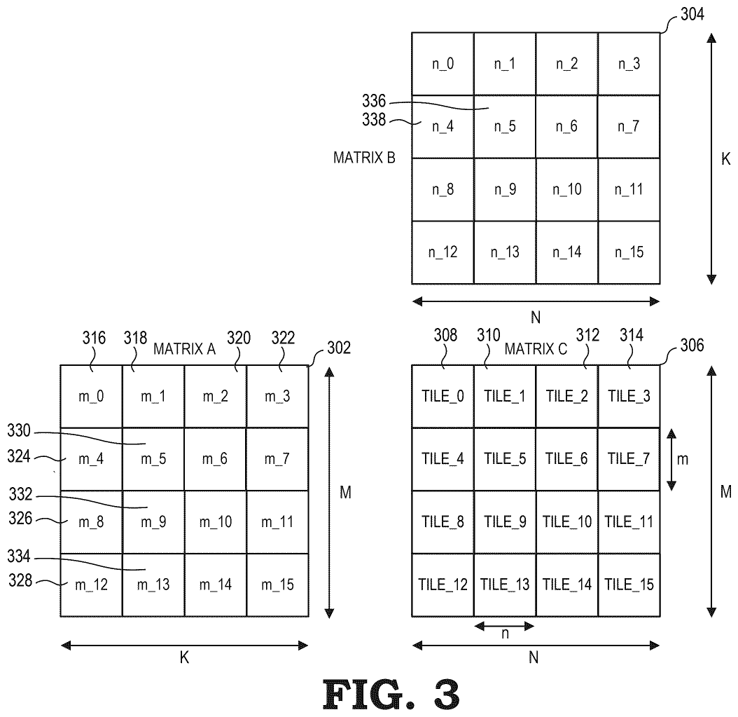

For example, FIG. 3 shows an example of a tiling technique for GEMM kernel execution. In FIG. 3, a first matrix 302 (also referred to herein as “Matrix A 302”), a second matrix 304 (also referred to herein as “Matrix B 304”), and a third matrix 306 (also referred to herein as “Matrix C 306”) are illustrated. Matrix A 302 is of size M×K with M being the number of rows and K being the inner dimension), Matrix B 304 is of size K×N, and Matrix C 306 is the result matrix of size M×N. In this example, consider Tile_1 310 of Matrix C 306. The calculation of this output tile involves the computation of four partial products. These partial products (also referred to as “partial results” or “intermediate results”) are typically computed within a loop. During the initial iteration of the loop, the tile m_0 316 from Matrix A 302 is multiplied by the tile n_4 336 from Matrix B 304 to produce the first partial product. In the subsequent iteration, the tile m_1 318 from Matrix A 302 is multiplied by the tile n_5 338 from Matrix B 306 to yield the second partial product, and this process continues for the remaining iterations. These partial products are then summed together to obtain the final result for Tile_1 310 of Matrix C 306.

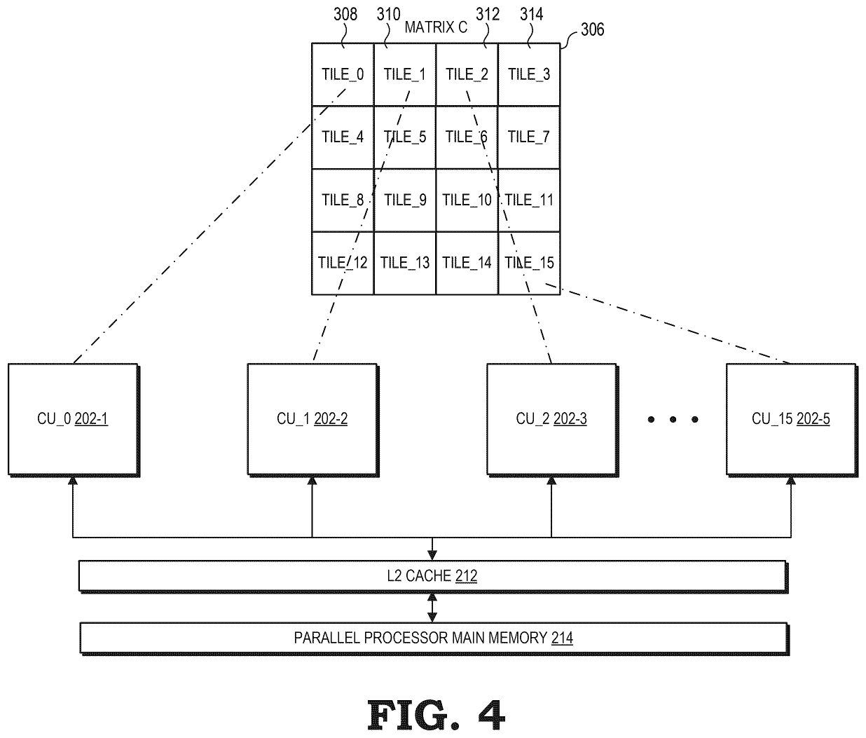

For execution on a parallel processor 104, each output tile from Matrix C 306 is assigned to a workgroup. These workgroups are scheduled across the available compute units 202 for execution, as shown in FIG. 4. When the GEMM kernel 216 is executed on the parallel processor 104, a scheduling policy allocates workgroups to available compute units in sequence. For instance, workgroup_0 for Tile_0 308 is scheduled on compute unit CU_0 202-1, workgroup_1 for Tile_1 310 is scheduled on compute unit CU_1 202-2, workgroup_2 for Tile_2 312 is scheduled on compute unit CU_1 202-2, and workgroup_3 for Tile_3 314 is scheduled on compute unit CU_3 202-4, as long as the compute units 202 are available. This scheduling mechanism ensures efficient utilization of the parallel processor's computational resources.

However, conventional GEMM execution techniques typically result in increased latency and underutilization of the main memory 214 based, in part, on their inefficient data access patterns. For example, consider a conventional data access pattern for Matrix A 302, noting that the data access pattern for Matrix B 304 is similar. During runtime, in iteration 0, CU_0 202-1 (responsible for calculating Tile_0 308) sends a memory request to fetch tile m_0 316 from Matrix A 302. Simultaneously, CU_1 202-1 (responsible for calculating Tile_1 310) also sends a memory request for tile m_0 316. Since tile m_0 316 is accessed for the first time, these requests result in an L2 cache miss. Given that the requests are sent in close succession, they are combined in the memory system, specifically within the L2 cache 212, resulting in a single request for tile m_0 316 being sent to the main memory 214. Consequently, CU_0 202-1 and CU_1 202-2 must wait for this memory access to complete, increasing latency. Once the data for tile m_0 316 is returned, the compute units 202 proceed to calculate their partial products. In the next iteration, CU_0 202-1 and CU_1 202-2 request tile m_1 318, again resulting in an L2 cache miss. This leads to workgroups being stalled while waiting for data access from the main memory 214, which has higher latency compared to the L2 cache 212.

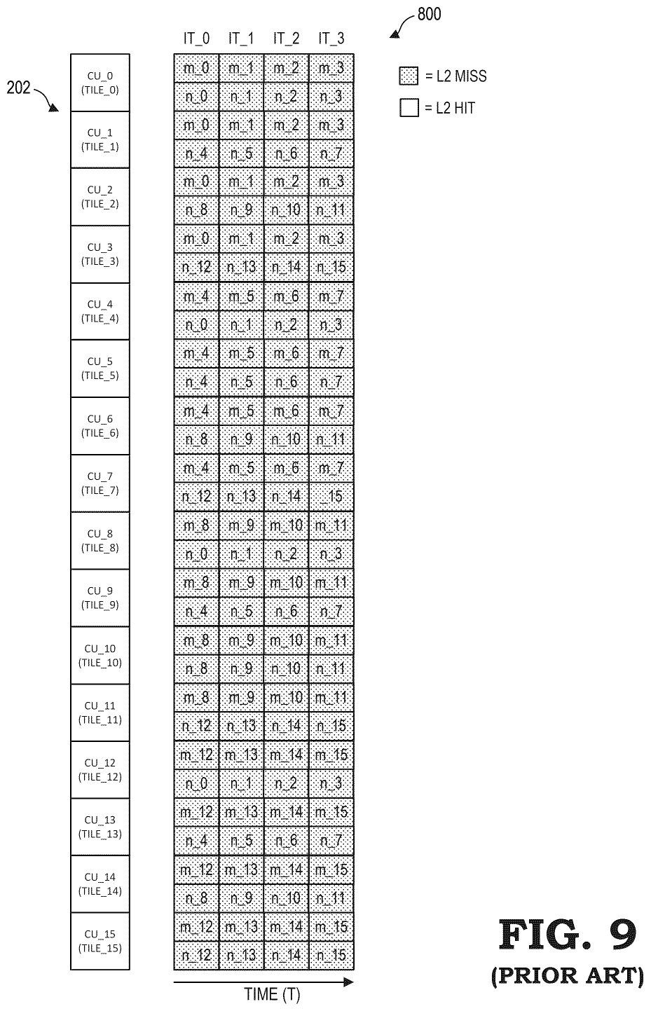

These unoptimized input data access patterns 900 are illustrated in FIG. 9. For example, in iteration 0 (IT_0), four memory requests are generated for tiles m_0, m_4,m_8, and m_12. The threads must wait for this data to be fetched from the main memory 214. In iteration 1 (IT_1), the compute units 202 attempt to operate on tiles m_1, m_5 330, m_9, and m_13, which are not cached in the L2 cache 212, resulting in additional delays as the compute units wait for the data to be fetched from the main memory 214. This inefficient pattern continues in iteration 2 (IT_2) and iteration 3 (IT_3), where similar cache misses occur, leading to repeated delays and underutilization of the memory system. As the memory accesses across iterations are not overlapped, the latencies accumulate, leading to a much higher overall kernel latency. Additionally, the main memory 214, which is capable of serving many requests in parallel, is underutilized. In the case of smaller GEMM kernels 216, where there is insufficient computational power to hide the latency, the kernel becomes memory access latency-bound, resulting in decreased performance.

As such, the parallel processor 104 implements one or more early memory access techniques that overlap memory accesses in different iterations of a GEMM loop to maximize the utilization of the L2 cache 212 and reduce overall kernel latency and thread stall cycles. The early memory access technique implemented by the parallel processor 104 optimizes memory accesses by initiating them as early as possible, thereby minimizing the accumulation of memory access latency. This approach also efficiently utilizes L2 cache capacity.

In at least some implementations, the parallel processor 104 adjusts the starting index of the tiling loop based on the workgroup or tile identifier (ID). For example, when multiple workgroups are executing simultaneously, such as workgroup_0 (e.g., calculating output Tile_0 308 and scheduled on CU_0 202-1) and workgroup_1 (calculating output Tile_1 310 and scheduled on CU_1 202-2), the workgroups access tiles of input data in the initial iterations. In at least some implementations, these tiles are distinct from each other (e.g., non-overlapping). By doing so, this technique generates a larger number of memory requests initially, which leads to an increased L2 hit rate subsequently. This is because the data required by subsequent workgroups has already been accessed earlier by preceding workgroups and cached in the system, thereby reducing the need for re-accessing the same data and thereby minimizing latency.

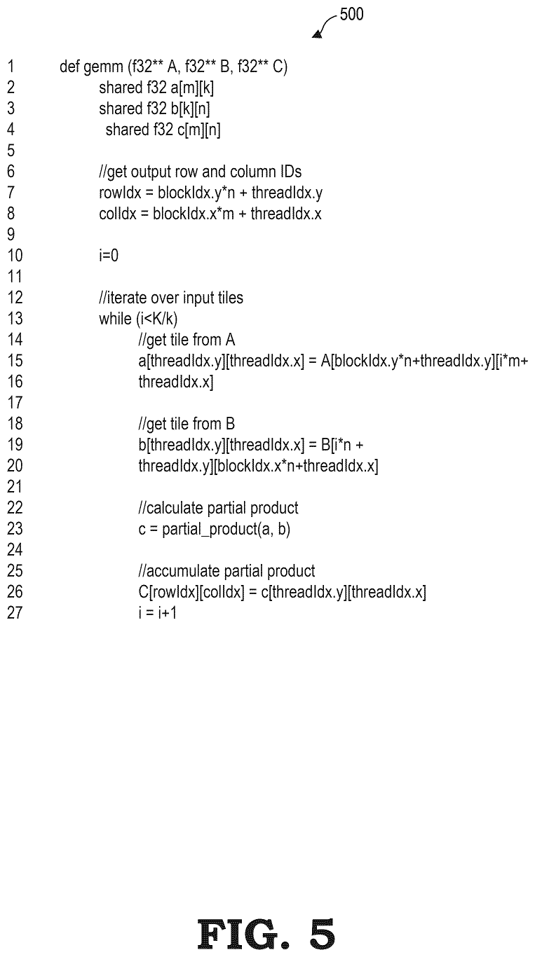

FIG. 5 illustrates example pseudocode of an early memory access algorithm 500 implemented by the parallel processor 104 for executing a GEMM kernel 216 such that memory accesses are overlapped in different iterations of the GEMM loop. It is understood that other implementations of the early memory access technique described herein are applicable as well. At line 1, a function referred to as “gemm_optimized” takes three input matrices as arguments: “A”, “B”, and “C” The “f32**” notation indicates that these are floating-point matrices of two dimensions. This technique is applicable to any datatype (e.g., integer or floating point of any precision) and dimensionality. At lines 2 to 4, three shared memory arrays: “a”, “b”, and “c” are declared. Each array has dimensions matching the tile sizes “(m, k)” or “(k, n)”. In this example, shared memory is used to store temporary results within a thread block.

At lines 7 and 8, the gemm_optimized function computes the row and column indices (“rowIdx” and “colIdx”) of the output tile being processed. This is done by combining the block coordinates (“blockIdx”) with the thread coordinates (“threadIdx”), taking into account the dimensions (“n” and “m”) of the input Matrix A and Matrix B. The resulting row and column indices are used to determine which tile from the output Matrix C needs to be updated. There can be multiple ways to calculate the tile starting indices. The above is just one example. At line 10, the gemm_optimized function initializes a variable “idx” to the x-coordinate of the current block. This variable will be used as an offset for fetching input tiles from Matrix A and Matrix B.

At line 14, the gemm_optimized function initiates an outer loop that iterates over the input tiles, checking if the current tile index idx is within the range of available tiles (“K/k” plus the block x-coordinate). The condition takes into account that each block can process multiple tiles. Within each iteration of the outer loop, the gemm_optimized function, at line 15, computes the tile index “i” for fetching input tiles from Matrix A and Matrix B. At lines 17 and 18, the gemm_optimized then fetches a tile from Matrix A, and at lines 21 and 22, it fetches another tile from Matrix B using the computed tile index i and the block coordinates and thread coordinates to compute the initial offsets.

At line 25, the gemm_optimized function calls a “partial_product” function that performs the actual matrix multiplication using the loaded tiles. The result is stored in a shared memory array “c”. At line 29, the gemm_optimized function accumulates the partial product results into the output Matrix C. The tile index idx is then incremented to process the next tiles from Matrices A and B in the next outer loop iteration. The loop continues until all inner dimension tiles have been processed.

The early memory access algorithm of FIG. 5 is advantageous over conventional GEMM execution techniques because different thread blocks aim to access different input tiles. This allows for a higher number of memory requests in the initial iterations and results in L2 cache hits and lower memory access latency in subsequent iterations, leading to improved performance. As an example, consider Matrix A 302, Matrix B 304, and Matrix C 306 depicted in FIG. 3. The parallel processor 104 divides the output Matrix C 306 into 16 tiles (Tiles 0 to 15), which are subsequently mapped to workgroups 0 to 16. Each workgroup corresponds to a compute unit 202 responsible for calculating a specific output tile. This mapping is illustrated in FIG. 4. Now consider the calculation of output tiles 0 to 3, which are executed in parallel on CU_0 202-1 to CU_3 202-4. In this example, output tiles concurrently access data from input Matrix A 302, specifically input tiles m_0 316 to m_3 322 over four partial product loop iterations 602.

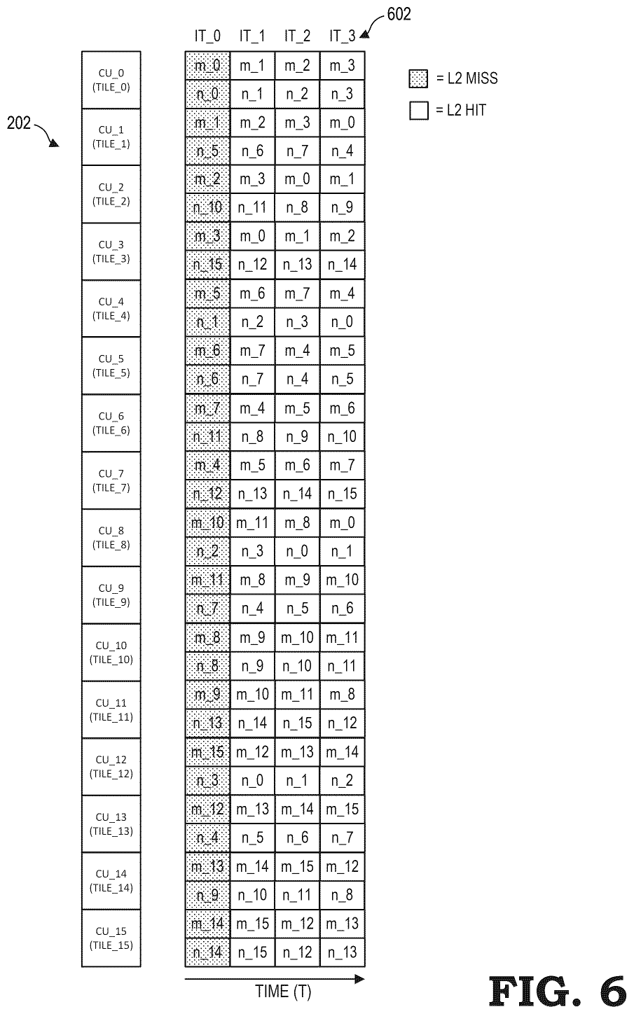

As described above with respect to FIG. 9, conventional unoptimized techniques result in a high number of L2 cache misses and a small number of inflight memory requests at any given time. However, the early memory access technique implemented by the parallel processor 104 addresses this issue by introducing an optimized memory access pattern. For example, as shown in FIG. 6, instead of multiple compute units 202 accessing the same tile (e.g., m_0 316) in the first loop iteration (IT_0), the compute units 202 access consecutive tiles. For example, CU_0 202-1 accesses m_0 316, CU_1 202-2 accesses m_1 318, CU_2 202-3 accesses m_2 320, and CU_3 202-4 accesses m_3 322. This optimized access pattern results in four requests being issued to memory instead of a single request in the conventional unoptimized technique. Also, these requests are overlapped, which allows for their access latency to be overlapped as well. In the second iteration (IT_2), when CU_0 202-1 attempts to access data from tile m_1 318, CU_0 202-1 exploits the fact that this tile has already been cached in the L2 cache 212 as a result of CU_1 202-2 accessing this data in the first iteration. Therefore, CU_0 202-1 accesses the data from tile m_1 318 at a much lower latency path than with the conventional unoptimized technique, which reduces stall cycles and overall kernel latency. The same optimized memory access pattern is extended to tiles of Matrix B 304.

The loop reindexing of one or more implementations allows for the L2 cache capacity and memory throughput to be maximized while minimizing end-to-end kernel latency. This technique, when applied across multiple iterations and matrices, increases memory bandwidth utilization, reduces L2 cache misses, and improves overall kernel performance. It is understood that although the early access techniques of one or more implementations were described with reference to parallel processor based GEMMs, these techniques also apply to other platforms, such as CPU or FPGA based GEMMs. Also, the described early access techniques are applicable to any scenario where multiple compute units are accessing the same data at the same time, resulting in memory requests being combined. Examples of this include image/signal processing algorithms, such as convolutions, filtering, and the like.

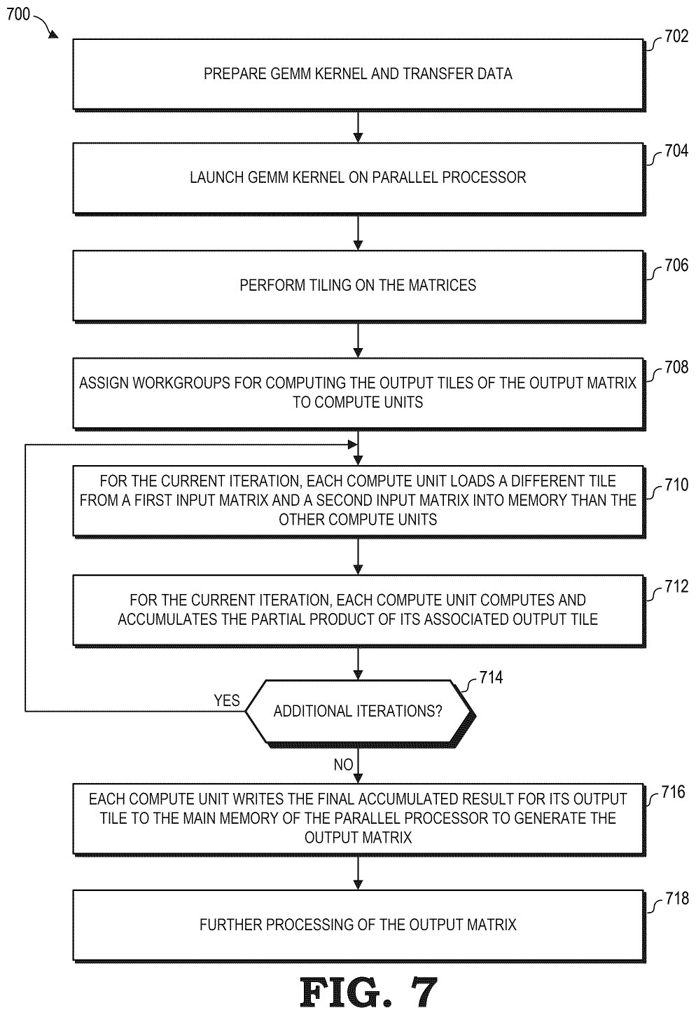

FIG. 7 is a diagram illustrating an example method 700 of a parallel processor 104 implementing an early memory access technique that overlaps memory accesses in different iterations of a GEMM kernel loop to maximize the utilization of the L2 cache 212 and reduce overall kernel latency and thread stall cycles. The processes described below with respect to the method 700 have been described above in greater detail with reference to FIG. 1 to FIG. 6. It should be understood that method 700 is not limited to the sequence of operations shown in FIG. 7, as at least some of the operations can be performed in parallel or in a different sequence. Moreover, in at least some implementations, the method 700 can include one or more different operations than those shown in FIG. 7.

At block 702, a host processor, such as the application processor 102 (e.g., CPU 102), prepares a GEMM kernel 216 and transfers data associated with the GEMM kernel 216 to the main memory 214 of the parallel processor 104. For example, the GEMM kernel 216 is compiled into machine code suitable for execution on the parallel processor 104. Memory on the parallel processor 104 for the matrices (e.g., input Matrix A 302, input Matrix B 306, and output Matrix C 306) involved in the computation and any temporary buffers required during the execution are allocated. The host processor copies input Matrix A 302 and input Matrix B 304 from its system memory 106 to the main memory 214 of the parallel processor 104.

At block 704, the GEMM kernel 216 is launched on the parallel processor 104. For example, the grid and block dimensions are defined for the GEMM kernel execution and determine how the computation is divided among the parallel processor's compute and work items. The GEMM kernel 216 is then launched on the parallel processor 1016 using, for example, an appropriate API call. At block 706, the parallel processor 104 performs a tiling operation, as part of the GEMM operation, that divides Matrix A 302, Matrix B 304, and Matrix C 306 into smaller submatrices or tiles. This tiling process determines how the matrices will be broken down into manageable pieces that can be processed by the parallel processor's compute units 202 in parallel.

At block 708, the parallel processor 104 assigns workgroups for computing the output tiles of Matrix C 306 to its compute units 202. For example, the parallel processor 104 identifies the workgroups based on the grid dimensions defined for the computation. The workgroups are initialized and assigned to compute units 202 for efficient parallel processing. The workgroups are responsible for computing different tiles of the output Matrix C 306. For example, workgroup_0 is assigned to compute a first output tile of Matrix C 306, workgroup_1 is assigned to compute a second output tile of Matrix C 306, workgroup_2 is assigned to compute a third output tile of Matrix C 306, and workgroup_3 is assigned to compute a fourth output tile of Matrix C 306, and so on. It should be understood that this assignment is not specific and the techniques described herein are applicable even when multiple workgroups are computing a single output tile or a single workgroup is computing multiple output tiles.

Once the workgroups are defined, a scheduler of the parallel processor 104 assigns the workgroups to specific compute units 202. For example, CU_0 202-1 is assigned to workgroup_0 and is responsible for computing the first output tile of Matrix C 306 using tiles from Matrix A 302 and Matrix B 304. Similarly, CU_1 202-2 is assigned to workgroup_1 and is responsible for computing the second output tile of Matrix C 306 using tiles from Matrix A 302 and Matrix B 304. CU_2 202-3 is assigned to workgroup_2 and is responsible for computing the third output tile of Matrix C 306 using tiles from Matrix A 302 and Matrix B 304. CU_3 202-4 is assigned to workgroup_3 to compute the fourth output tile of Matrix C 306 using tiles from Matrix A 302 and Matrix B 304.

At block 710, for the current iteration, each compute unit 202 loads a different input tile from Matrix A 302 and Matrix B 304 into shared memory, such as the scratchpad memory 210, provided that the input matrices are large enough to have as many different tiles as possible. If the input matrices are smaller, then the technique seeks to maximize the number of different input tiles loaded, but each compute unit 202, in at least some instances, may not load unique tiles from Matrix A and Matrix B. For example, CU_0 202-1 loads tile m_0 from Matrix A 302 and tile n_0 from Matrix B 304, CU_1 202-2 loads tile m_1 from Matrix A 302 and tile n_5 from Matrix B 304, CU_2 202-3 loads tile m_2 from Matrix A 302 and tile n_10 from Matrix B 304, and CU_3 202-4 loads tile m_3 from Matrix A 302 and tile n_15 from Matrix B 304. As such, instead of the compute units 202 accessing the same tiles for the same iteration, the compute units 202 access different tiles.

In at least some implementations, each compute unit 202 initially checks the L1 cache 206 to determine if the required tiles from Matrix A 302 and Matrix B are present. If a tile is found in the L1 cache 206 (cache hit), the tile is loaded directly into the shared memory. However, if a tile is not found in the L1 cache (cache miss), the data request is forwarded to L2 cache 212. If the tile is present in the L2 cache 212 (cache hit), the tile is then loaded into the shared memory. If the tile is also not found in the L2 cache 212 (cache miss), a request is made to load the tile from the main memory 214.

At block 712, for the current iteration, each compute unit 202 computes and accumulates the partial product of its associated output tile for Matrix C. For example, each thread within the compute unit 202 multiplies elements from the corresponding tiles of Matrix A 302 and Matrix B 304, performing the multiply-accumulate operations. Each thread multiplies the elements of its assigned row from the tile of Matrix A 302 with the elements of its assigned column from the tile of Matrix B 304 and adds the result to an accumulator variable (e.g., a register). This process continues for all elements in the tile, with each thread accumulating the results for its assigned output element. Once the threads of the compute unit 202 have computed their partial product, the results are stored in the shared memory. In at least some implementations, a synchronization barrier ensures that all threads within the block have completed their calculations and stored their partial results before proceeding to the next step. Stated differently, each compute unit 202 monitors a synchronization mechanism and waits until all threads within the block have completed their calculations and stored their partial results before performing an additional iteration or obtaining the final accumulated result.

At block 714, the parallel processor 104 determines if any additional iterations remain. For example, the parallel processor 104 checks a loop counter to determine if there are more iterations required to complete the matrix multiplication. If there are remaining iterations, the process returns to block 710, and the compute units 202 load new input tiles into shared memory. At block 716, if all iterations have been completed, each compute unit 202 sums its partial results to obtain a final accumulated result or value and writes the final accumulated result for its output tile to the main memory 214 of the parallel processor 104. This includes storing the computed values in the corresponding locations within the output Matrix C 306, thereby completing the computation for that specific tile. This process ensures that the output Matrix C 306 is gradually built up, tile by tile, with each compute unit contributing its portion of the results. The GEMM kernel execution concludes after all the tiles of the output Matrix C 306 have been fully computed and successfully written to the main memory 214 of the parallel processor. As a result, each element of output Matrix C 306 has been calculated by the corresponding compute units 202 through the multiply-accumulate operations and then stored in the appropriate position in the main memory 214. The final result is the fully computed Matrix C 306.

At block 718, the parallel processor 104 or another process performs further processing of the output Matrix C 306. For example, in at least some implementations, the output Matrix C 306 is implemented in one or more machine-learning applications. In this example, the output Matrix C 306 is used as an input to subsequent layers in a neural network, facilitating tasks such as image recognition, natural language processing, and predictive analytics. For instance, the output Matrix C 306 resulting from a convolutional layer in a neural network is used as the input for the next layer, enabling the network to learn and make accurate predictions based on the data.

In another example, the output Matrix C 306 is implemented in one or more high-performance computing (HPC) applications. In this example, the output Matrix C 306 provides matrix multiplication results for scientific simulations, including physics, chemistry, and biology. The output Matrix C 306, some instances, is also used in finite element analysis for engineering applications, such as structural analysis and fluid dynamics, providing precise computational results that are essential for designing and testing new materials and structures.

Further, the output Matrix C 306, in at least some implementations, is implemented in graphics processing applications. For example, the output Matrix C 306 is employed for three-dimensional (3D) model transformations, including scaling, rotation, and translation, to render realistic images and animations. Additionally, in some instances, the output Matrix C 306 is used in the rendering pipeline to compute lighting, shading, and other visual effects, enhancing the quality and realism of computer-generated imagery.

In at least some implementations, the output Matrix C 306 is implemented in signal processing applications. For example, the output Matrix C 306 is applied in digital signal processing for filtering, image processing, and other transformations, improving the clarity and quality of signals. In compression algorithms, the output Matrix C 306 aids in efficient data compression and decompression, optimizing storage and transmission of large datasets.

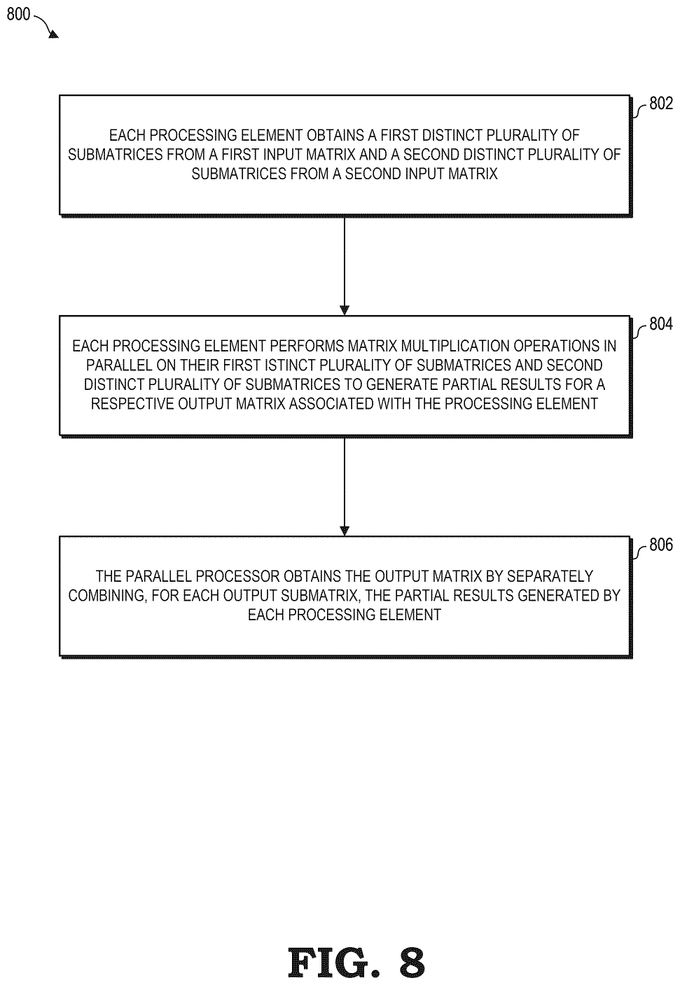

FIG. 8 is a diagram illustrating another example method 800 of a parallel processor 104 implementing the early memory access technique. The processes described below with respect to the method 800 have been described above in greater detail with reference to FIG. 1 to FIG. 7. It should be understood that the method 800 is not limited to the sequence of operations shown in FIG. 8, as at least some of the operations can be performed in parallel or in a different sequence. Moreover, in at least some implementations, the method 800 can include one or more different operations than those shown in FIG. 8.

At block 802, each processing element (e.g., compute unites 202) of a plurality of processing elements of the parallel processor 104 obtains a first plurality of submatrices from a first input matrix (e.g., Matrix A 302) and a second plurality of submatrices from a second input matrix (e.g., Matrix B 304). In at least some implementations, the first plurality of submatrices is distinct from the second plurality of submatrices. For example, for each iteration of a plurality of iterations, a processing element obtains a first submatrix from the first input matrix and a second submatrix from the second input matrix that are distinct from a corresponding first submatrix and a corresponding second matrix obtained by other processing elements of the plurality of processing elements. In at least some implementations, the processing element obtains the first plurality of submatrices and the second plurality of submatrices further by calculating the indices for accessing the input submatrices and determining that these indices are within bounds of the input matrices. In response to calculating the indices, the processing element obtains the first submatrix from the first input matrix and the second submatrix from the second input matrix. In at least some implementations, the processing element further obtains the first submatrix and the second submatrix based on computing submatrix indices for the first input matrix and second input matrix, based on workgroup indices and thread indices within a workgroup.

At block 804, each processing element performs matrix multiplication operations on the first plurality of submatrices and the second plurality of submatrices to generate partial results for an output submatrix of an output matrix (e.g., Matrix C 306) associated with the processing element. In at least some implementations, each of the processing elements performs the matrix multiplication operations in parallel for a current iteration of a plurality of iterations on their first input matrix and second submatrix to generate partial results for their output submatrix. At block 806, the parallel processor 104 obtains the output matrix by combining the partial results for each output submatrix associated with each processing element separately. Each processing element generates a portion of the output matrix by combining the partial results in its scratchpad memory 210 to generate the output submatrix. In at least some implementations, each processing element, in response to all iterations of a plurality of iterations having been completed, combines the partial results from each iteration to obtain a final result for the output submatrix. Also, in at least some implementations, the output matrix is obtained based on each processing element calculating a row index and a column index for their output submatrix based on a block index and a thread index and responsive to calculating the row index and the column index, using the row index and the column index to determine the location in memory where their partial results are stored and accumulated.

The output matrix, in at least some implementations, is processed by the parallel processor 104 to perform, for example, graphics processing on graphical objects and render one or more images based on performing the graphics processing on the graphical objects. In at least some implementations, processing the output matrix includes using the output matrix to perform at least one of scaling transformations, rotation transformation, translation transformations, lighting effects, or shading effects on the graphical objects.

One or more of the elements described above is circuitry designed and configured to perform the corresponding operations described above. Such circuitry, in at least some implementations, is any one of, or a combination of, a hardcoded circuit (e.g., a corresponding portion of an application-specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some implementations, the circuitry for a particular element is selected, arranged, and configured by one or more computer-implemented design tools. For example, in some implementations, the sequence of operations for a particular element is defined in a specified computer language, such as a register transfer language and a computer-implemented design tool selects, configures, and arranges the circuitry based on the defined sequence of operations.

Within this disclosure, in some cases, different entities (which are variously referred to as “components”, “units”, “devices”, “circuitry”, etc.) are described or claimed as “configured” to perform one or more tasks or operations. This formulation of [entity] configured to [perform one or more tasks] is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to”. An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

In some implementations, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that may cause any benefit, advantage, or solution to occur or become more pronounced are not to be construed as a critical, required, or essential feature of any or all the claims. Moreover, the particular implementations disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular implementations disclosed above may be altered or modified and all such variations are considered within the scope of the disclosed subject matter. Accordingly, the protection sought herein is as set forth in the claims below.

What is claimed is:

1. A method at a parallel processor of a computing system, comprising:
obtaining, by each processing element of a plurality of processing elements of the parallel processor, a first plurality of submatrices from a first input matrix and a second plurality of submatrices from a second input matrix, each of the first plurality of submatrices and the second plurality of submatrices including at least one submatrix that is distinct from submatrices obtained by other processing elements of the plurality of processing elements from the first input matrix and the second input matrix;
performing, by each processing element in parallel, one or more matrix multiplication operations on the first plurality of submatrices and the second plurality of submatrices to generate corresponding partial results for an output submatrix of an output matrix; and
obtaining, by the parallel processor, the output matrix by combining the partial results for each output submatrix.

2. The method of claim 1, wherein obtaining the first plurality of submatrices and the second plurality of submatrices comprises:
obtaining, by each processing element for each iteration of a plurality of iterations, a first submatrix from the first input matrix and a second submatrix from the second input matrix that are distinct from a corresponding first submatrix and a corresponding second submatrix obtained by other processing elements of the plurality of processing elements.

3. The method of claim 2, wherein obtaining the first plurality of submatrices and the second plurality of submatrices further comprises:
calculating indices for accessing the first submatrix and the second submatrix; and
responsive to determining the indices are within bounds of the first input matrix and the second input matrix, obtaining the first submatrix from the first input matrix and the second submatrix from the second input matrix.

4. The method of claim 2, wherein obtaining the first submatrix and the second submatrix comprises:
computing submatrix indices for the first input matrix and the second input matrix based on one or more workgroup indices; and
obtaining the first submatrix and the second submatrix based on the submatrix indices.

5. The method of claim 2, wherein performing the one or more matrix multiplication operations comprises:
performing, by each processing element in parallel for a current iteration of the plurality of iterations, the one or more matrix multiplication operations on the first input matrix and the second submatrix to generate corresponding partial results for the output submatrix.

6. The method of claim 5, wherein obtaining the output matrix comprises:
responsive to all iterations of the plurality of iterations having been completed, combining, by each processing element, the partial results from each iteration to obtain a final result for the output submatrix.

7. The method of claim 1, further comprising:
processing the output matrix to perform graphics processing on one or more graphical objects; and
rendering one or more images based on the graphics processing.

8. The method of claim 7, wherein processing the output matrix includes performing at least one of a scaling transformation, a rotation transformation, a translation transformation, a lighting effect, or a shading effect on the one or more graphical objects using the output matrix.

9. A processor, comprising:
a plurality of processing elements, each processing element configured to;
obtain a first plurality of submatrices from a first input matrix and a second plurality of submatrices from a second input matrix, each of the first plurality of submatrices and the second plurality of submatrices including at least one submatrix that is distinct from submatrices obtained by other processing elements of the plurality of processing elements from the first input matrix and the second input matrix;
perform one or more matrix multiplication operations on the first plurality of submatrices and the second plurality of submatrices to generate corresponding partial results for an output submatrix of an output matrix associated with the processing element; and
generate a portion of the output matrix by combining the partial results in memory for the output submatrix.

10. The processor of claim 9, wherein at least one processing element of the plurality of processing elements is configured to obtain the first plurality of submatrices and the second plurality of submatrices by:
obtaining, for each iteration of a plurality of iterations, a first submatrix from the first input matrix and a second submatrix from the second input matrix that are distinct from a corresponding first submatrix and a corresponding second submatrix obtained by other processing elements of the plurality of processing elements.

11. The processor of claim 10, wherein the at least one processing element is configured to obtain the first plurality of submatrices and the second plurality of submatrices further by:
calculating indices for accessing the first submatrix and the second submatrix; and
responsive to determining the indices are within bounds of the first input matrix and the second input matrix, obtaining the first submatrix from the first input matrix and the second submatrix from the second input matrix.

12. The processor of claim 10, wherein the at least one processing element is configured to obtain the first submatrix and the second submatrix by:
computing submatrix indices for the first input matrix and the second input matrix based on one or more workgroup indices; and
obtaining the first submatrix and the second submatrix based on the submatrix indices.

13. The processor of claim 10, wherein the at least one processing element is configured to perform the one or more matrix multiplication operations by:
performing, for a current iteration of the plurality of iterations, the one or more matrix multiplication operations on the first submatrix and the second submatrix to generate corresponding partial results for the output submatrix.

14. The processor of claim 13, wherein the at least one processing element is configured to obtain the output matrix by:
responsive to all iterations of the plurality of iterations having been completed, combining, the partial results from each iteration to obtain a final result for the output submatrix.

15. The processor of claim 9, wherein at least one processing element of the plurality of processing elements is further configured to:
perform graphics processing on one or more graphical objects based on the output matrix; and
render one or more images based on the graphics processing.

16. A processor, comprising:
a plurality of processing elements, each processing element, for a plurality of matrix multiply iterations, configured to:
obtain tiles from at least a first input matrix and a second input matrix, wherein the tiles obtained for a first iteration of the plurality of matrix multiply iterations by the plurality of processing elements are consecutive to each other;
perform one or more multiply-accumulate operations on the tiles to generate corresponding partial products for an output tile of an output matrix associated with the processing element; and
generate a portion of the output matrix by combining the partial products in memory for the output tile.

17. The processor of claim 16, wherein at least one processing element of the plurality of processing elements is further configured to:
perform graphics processing on one or more graphical objects based on the output matrix; and
render one or more images based on the graphics processing.

18. The processor of claim 16, wherein at least one processing element of the plurality of processing elements is configured to:
responsive to monitoring a synchronization mechanism, proceeding with a next matrix multiply iteration of the plurality of matrix multiply iterations or waiting until all threads, of the at least one processing element, performing the one or more multiply-accumulate operations have stored their partial products before proceeding with the next matrix multiply iteration.

19. The processor of claim 16, wherein at least one processing element of the plurality of processing elements is configured to obtain the tiles by:
calculating indices for accessing a first tile associated with the first input matrix and a second tile associated with the second input matrix; and
responsive to determining the indices are within bounds of the first input matrix and the second input matrix, obtaining the first tile from the first input matrix and the second tile from the second input matrix.

20. The processor of claim 16, wherein at least one processing element of the plurality of processing elements is configured to obtain the tiles by:
computing submatrix indices for the first input matrix and the second input matrix based on one or more workgroup indices; and
obtaining at least a first tile and a second tile based on the submatrix indices.
